(19) United States
(12) Patent Application Publication
(10) Pub. No.: US 2024/0272932 A1
(43) Pub. Date: Aug. 15, 2024

(54) METHOD AND APPARATUS FOR LIVE MIGRATION BASED ON REMOTE DIRECT MEMORY ACCESS, AND DEVICE

(71) Applicant: HANGZHOU ALICLOUD FEITIAN INFORMATION TECHNOLOGY CO., LTD., Hangzhou (CN)

(72) Inventor: Yilong LYU, Hangzhou (CN)

(21) Appl. No.: 18/681,007

(22) PCT Filed: Jul. 26, 2022
(86) PCT No.: PCT/CN2022/107930

§ 371 Date: Feb. 2, 2024

(30) Foreign Application Priority Data
Aug. 2, 2021 (CN) 202110880048.6

(51) Int. Cl. G06F 9/455

(52) U.S. Cl. CPC G06F 9/45558; G06F 2009/4557

(57) ABSTRACT

Embodiments of the present disclosure provide a method and an apparatus for live migration based on remote direct memory access, and a device. The method for live migration includes: obtaining a live migration request, where the live migration request includes a to-be-migrated virtual machine; generating a relay routing corresponding to the to-be-migrated virtual machine based on the live migration request; performing a live migration operation of the to-be-migrated virtual machine based on the relay routing. According to the technical solution provided by this embodiment, the live migration operation of the to-be-migrated virtual machine is performed through the relay routing, so that RDMA access of other physical machines to the current physical machine undergoing the live migration operation can be not interrupted, RDMA data can be not lost, and users can be unaware.

### CROSS-REFERENCE TO RELATED APPLICATIONS

The present application is a National Stage of International Application No. PCT/CN2022/107930, filed on Jul. 26, 2022, which claims priority to Chinese Patent Application No. 202110880048.6, titled “METHOD AND APPARATUS FOR LIVE MIGRATION BASED ON REMOTE DIRECT MEMORY ACCESS, AND DEVICE” and filed on Aug. 2, 2021. These applications are hereby incorporated by reference in their entireties.

### TECHNICAL FIELD

The present disclosure relates to the field of data processing technologies and, in particular, to a method and an apparatus for live migration based on remote direct memory access, and a device.

### BACKGROUND

Live migration (also called dynamic migration, or real-time migration), i.e., virtual machine saving/restoring is to completely save the entire running status of a virtual machine, which at the same time, can be quickly restored onto an original hardware platform or even a different hardware platform. After the restoring, the virtual machine still runs smoothly, and users will not notice any difference.

In cloud networks, users all use virtual machines, such as an elastic compute service (ECS for short), network interface controllers of which are typically implemented by software virtualization and do not have the capability of remote direct memory access (RDMA for short) of hardware network interface controllers. Secondly, current cloud networks are typically based on private cloud (Virtual Private Cloud, VPC for short) networks implemented by overlay networks, and traditional RDMA technologies cannot be used thereon. Finally, due to the network virtualization in the cloud networks, the networks of users do not want to be limited by a physical network topology, while traditional RDMA's perception of the physical network is very important.

In addition, since live migration can avoid risks and failures caused by underlying hardware or systems, and live migration is also an effective means of resource transfer, it is of great significance to provide a live migration method that supports the VPC architecture of the cloud network and makes users unaware.

### SUMMARY

Embodiments of the present disclosure provide a method and an apparatus for live migration based on remote direct memory access, and a device, which enable RDMA access of other physical machines to a current physical machine undergoing a live migration operation to be not interrupted, RDMA data to be not lost, and users to be unaware, during performing the live migration operation.

In a first aspect, an embodiment of the present disclosure provides a method for live migration based on remote direct memory access, including:
obtaining a live migration request, where the live migration request includes a to-be-migrated virtual machine:
generating a relay routing corresponding to the to-be-migrated virtual machine based on the live migration request:
performing a live migration operation of the to-be-migrated virtual machine based on the relay routing.

In a second aspect, an embodiment of the present disclosure provides an apparatus for live migration based on remote direct memory access, including:
a first obtaining module, configured to obtain a live migration request, where the live migration request includes a to-be-migrated virtual machine:
a first generating module, configured to generate a relay routing corresponding to the to-be-migrated virtual machine based on the live migration request:
a first processing module, configured to perform a live migration operation of the to-be-migrated virtual machine based on the relay routing.

In a third aspect, an embodiment of the present disclosure provides an electronic device, including: a memory and a processor: where the memory is configured to store one or more computer instructions, and when the one or more computer instructions are executed by the processor, the method for live migration based on remote direct memory access according to the first aspect mentioned above is implemented.

In a fourth aspect, an embodiment of the present disclosure provides a computer storage medium, where the computer storage medium is configured to store a computer program, and when the computer program is executed by a computer, the method for live migration based on remote direct memory access according to the first aspect mentioned above is implemented.

In a fifth aspect, an embodiment of the present disclosure provides a computer program product, including: a computer-readable storage medium storing thereon computer instructions which, when executed by one or more processors, cause the one or more processors to perform the steps in the method for live migration based on remote direct memory access illustrated in the first aspect mentioned above.

In a sixth aspect, an embodiment of the present disclosure provides an apparatus for live migration based on remote direct memory access, including:
a physical machine, configured to generate a live migration request, and send the live migration request to a network interface controller, where the live migration request includes a to-be-migrated virtual machine:
the network interface controller, configured to obtain the live migration request, generate a relay routing corresponding to the to-be-migrated virtual machine based on the live migration request, and perform a live migration operation of the to-be-migrated virtual machine based on the relay routing.

According to the technical solutions of the embodiments, through obtaining the live migration request, then generating the relay routing corresponding to the to-be-migrated virtual machine based on the live migration request, and performing the live migration operation of the to-be-migrated virtual machine based on the relay routing, it is effectively realized that in the process of conducting live migration of the virtual machine, RDMA access of other physical machines to the current physical machine undergoing the live migration operation can be not interrupted and RDMA data can be not lost through the relay routing, thereby effectively ensuring that the traffic is uninterrupted during the whole RDMA live migration process based on the overlay network architecture, and making users unaware, which further improves the good usage experience of the users and ensures the practicability of the technical solutions.

### BRIEF DESCRIPTION OF DRAWINGS

In order to illustrate the technical solutions of embodiments of the present disclosure or the prior art more clearly, the drawings required for the description of the embodiments or the prior art will be briefly introduced below: Obviously, the drawings in the following description are intended for some embodiments of the present disclosure: and for those of ordinary skill in the art, other drawings can be obtained according to these drawings without making creative efforts.

FIG. 1 is a schematic diagram of a principle of a method for message forwarding provided by an embodiment in the related art.

FIG. 2 is a principle block diagram of a method for live migration based on remote direct memory access provided by an embodiment of the present disclosure.

FIG. 3 is a schematic flowchart of a method for live migration based on remote direct memory access provided by an embodiment of the present disclosure.

FIG. 4 is a schematic flowchart of migrating a to-be-migrated virtual machine from a current physical machine to a target physical machine based on a software module and a relay routing provided by an embodiment of the present disclosure.

FIG. 5 is another schematic flowchart of migrating a to-be-migrated virtual machine from a current physical machine to a target physical machine based on a software module and a relay routing provided by an embodiment of the present disclosure.

FIG. 6 is a schematic flowchart of another method for live migration based on remote direct memory access provided by an embodiment of the present disclosure.

FIG. 7 is a schematic flow chart of still another method for live migration based on remote direct memory access provided by an embodiment of the present disclosure.

FIG. 8 is a schematic flowchart of yet another method for live migration based on remote direct memory access provided by an embodiment of the present disclosure.

FIG. 9 is a first schematic diagram of a method for live migration based on remote direct memory access provided by an application embodiment of the present disclosure.

FIG. 10 is a second schematic diagram of a method for live migration based on remote direct memory access provided by an application embodiment of the present disclosure.

FIG. 11 is a third schematic diagram of a method for live migration based on remote direct memory access provided by an application embodiment of the present disclosure.

FIG. 12 is a schematic diagram of a message in a method for live migration based on remote direct memory access provided by an application embodiment of the present disclosure.

FIG. 13 is a fourth schematic diagram of a method for live migration based on remote direct memory access provided by an application embodiment of the present disclosure.

FIG. 14 is a schematic structural diagram of an apparatus for live migration based on remote direct memory access provided by an embodiment of the present disclosure.

FIG. 15 is a schematic structural diagram of an electronic device corresponding to the apparatus for live migration based on remote direct memory access provided by the embodiment shown in FIG. 14.

FIG. 16 is a schematic structural diagram of another apparatus for live migration based on remote direct memory access provided by an embodiment of the present disclosure.

### DESCRIPTION OF EMBODIMENTS

In order to make the purposes, technical solutions, and advantages of embodiments of the present disclosure clearer, the technical solutions in the embodiments of the present disclosure will be clearly and completely described below in conjunction with the drawings in the embodiments of the present disclosure. Obviously, the described embodiments are part of the embodiments of the present disclosure, rather than all of the embodiments. Based on the embodiments in the present disclosure, all other embodiments obtained by those of ordinary skill in the art without making creative work shall fall within the protection scope of the present disclosure.

The terminology used in the embodiments of the present disclosure is merely intended for describing specific embodiments and is not intended to limit the present disclosure. The singular forms “a”, “said” and “the” as used in the embodiments and the appended claims of the present disclosure are intended to include the plural forms as well, and unless the context clearly indicates other meaning, “a plurality of” generally includes at least two, but it does not exclude the case of including at least one.

It should be understood that the term “and/or” used herein is only an association relationship describing the associated objects, which means that there can be three kinds of relationships, for example, A and/or B can mean: there are three cases where A exists alone, both A and B exist, and B exists alone. In addition, the character “/” herein generally indicates that the associated objects before and after are in an “or” relationship.

Depending on the context, the word “if”' or “in a case of” as used herein may be interpreted as “upon . . . ”, “when . . . ”, or “in response to determining . . . ” or “in response to detecting . . . ”. Similarly, depending on the context, the phrase “if it is determined that . . . ” or “if it is detected that (a stated condition or event)” may be interpreted as “when determining that . . . ” or “in response to determining . . . ”, or “when detecting (a stated condition or event)” or “in response to detecting (a stated condition or event)”.

It should also be noted that the terms “including”, “comprising” or any other variations thereof are intended to cover non-exclusive inclusions, such that goods or systems including a series of elements include not only those elements, but also other elements not expressly listed, or elements inherent to the goods or systems. Without more restrictions, an element defined by the phrase “including a” does not exclude the existence of other identical elements in the goods or systems that include the element.

In addition, the sequence of steps in the following method embodiments is merely intended for an example and is not strictly limited.

In order to facilitate understanding of the specific implementation process and implementation effect of a method for message forwarding based on remote direct memory access RDMA in the embodiments, the relevant technologies are briefly described as follows.

With the development of bandwidth and speed of networks, the demand for migration of large amounts of data is becoming more and more extensive, and the growth rate of network bandwidth is much higher than the capacity of computing nodes and the demand for memory bandwidth that are necessary when processing network traffic. The network architecture of data centers has gradually become a bottleneck in the development of computing and storage technologies, and therefore there is an urgent need to adopt a more efficient data communication architecture.

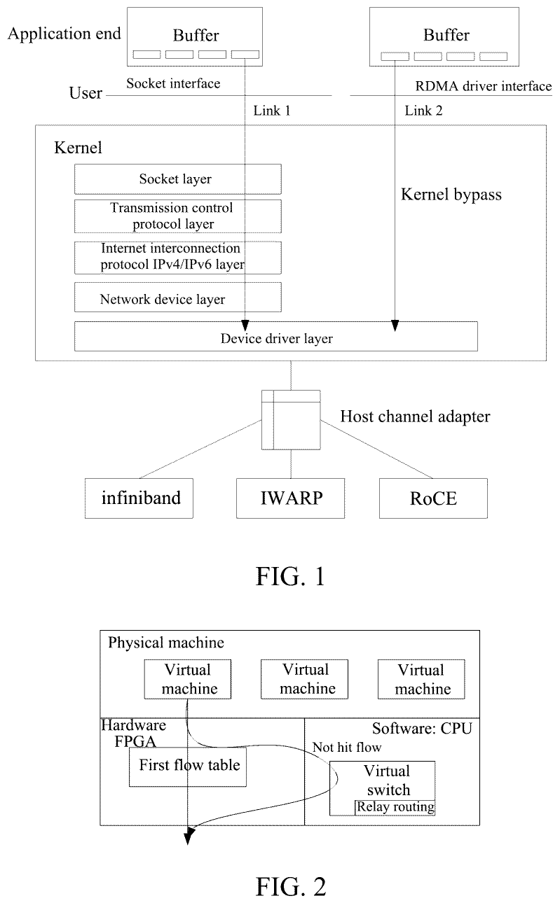

In the process of data packet processing, data packets have to go through an operating system and other software layers in traditional TCP/IP technologies. In link 1 as shown in FIG. 1, a message to be processed is sent from an application end to a kernel, and needs to pass through a socket layer (Sockets), a transmission control protocol layer (TCP), an Internet interconnection protocol IPv4/IPv6 layer, a network device layer (Network Device) and a device driver layer (Device Driver) in the kernel. At that point, for the message to be processed, not only the transmission link is very long, but also copying and transmission operations of the message need to be carried out when the message to be processed is transmitted, while the copying and transmission operations of the message are all done by a software module CPU (Central Processing Unit, CPU for short), which needs to occupy a lot of server resources and memory bus bandwidth and will then cause a large delay. In general, due to the huge overhead of the system, data is copied and moved back and forth between a system memory, a processor cache and a network controller cache, which places a heavy burden on the CPU and memory of the server, and especially in the face of the serious “mismatch” between network bandwidth, processing speed and memory bandwidth, it is more likely to aggravate the network delay effect.

Remote direct memory access (RDMA for short) allows a computer to directly access memories of other computers without the need for time-consuming transmission by a processor and the intervention of operating systems of both sides, allowing network communication with high throughput and low latency, which is especially suitable for use in large-scale parallel computer clusters. In link 2 as shown in FIG. 1, an RDMA technology has characteristics of quickly moving data from a system to a memory of a remote system without causing any impact on the operating systems. This technology can free up bus space and CPU cycle by eliminating copying and text exchange operations of the external memory, and can be used to improve the performance of application systems, thereby reducing the need for bandwidth and processor overhead and significantly reducing the delay.

In cloud networks, users all use virtual machines, such as an elastic compute service (ECS for short), network interface controllers of which are typically implemented by software virtualization and do not have the RDMA capability of hardware network interface controllers. Secondly, current cloud networks are typically private cloud (Virtual Private Cloud, VPC) networks based on overlay networks (encapsulating a traditional network message as a payload, for example, encapsulating it as Vxlan), and traditional RDMA technologies cannot be used thereon. Finally, due to the network virtualization in the cloud networks, the networks of users do not want to be limited by a physical network topology, while traditional RDMA's perception of the physical network is very important.

In addition, since live migration can avoid risks and failures caused by underlying hardware or systems, and live migration is also an effective means of resource transfer, it is of great significance to provide a live migration method that supports the VPC architecture of the cloud network and makes users unaware.

In order to solve the technical problem mentioned above, the embodiments provide a method and an apparatus for live migration based on remote direct memory access RDMA, and a device. The executive entity of the above method for live migration may be a live migration system. A message forwarding system can include a physical machine and a network interface controller communicatively connected to the physical machine, for example, the network interface controller is inserted into the physical machine, and one or more virtual machines (VMs) can be started within the physical machine. As shown in FIG. 2, the network interface controller includes therein a software module (CPU) and a hardware module, where the software module CPU can include a virtual switch (vswitch) that is responsible for normal VPC network traffic forwarding operations. Specifically, the software module can obtain a 5-tuple feature of a message, query a routing table, an access control list (ACL for short) table and other forwarding tables through the 5-tuple feature to obtain a query result, and then generate a second flow table based on the query result and the 5-tuple feature. The hardware module can use a field programmable gate array (FPGA for short) or an application specific integrated circuit (ASIC for short), and the hardware module can unload the second flow table issued by the software vswitch. When a message forwarding operation is conducted, the physical machine and a network interface controller node are used to implement the steps as follows.

The physical machine/virtual machine: generate a to-be-forwarded message, where the to-be-forwarded message at this point may include payload data and RDMA header information, and the RDMA header information may include direct data placement (DDP for short) header information and marker-based protocol data unit aligned (MPA) header information: send the to-be-forwarded message to the network interface controller. It should be noted that the live migration system can be realized by an iwarp network, and operation principles of live migration realized by other RDMA technologies such as rocev2 are similar.

The hardware module of the network interface controller: obtain the to-be-forwarded message sent by the physical machine/virtual machine, and perform encapsulating processing on a header of the to-be-forwarded message to obtain a processed message, that is, encapsulate the message including only the payload data and the RDMA header information to a complete message: then detect whether the processed message hits a first flow table pre-stored in the hardware module. The hardware module can forward the processed message directly based on the first flow table when the processed message hits the first flow table, and send the processed message to the software module of the network interface controller when the processed message does not hit the first flow table.

The software module of the network interface controller: obtain the processed message sent by the hardware module, and use the pre-stored second flow table corresponding to the processed message to perform forwarding processing on the processed message. After performing forwarding processing on the processed message, the software module may send the second flow table corresponding to the processed message to the hardware module to serve as the first flow table.

The live migration operation is illustrated by taking the FPGA as an example of the hardware module. When the live migration operation is performed on the live migration system:
the physical machine/virtual machine: configured to generate a live migration request, which may include a to-be-migrated virtual machine, and send the live migration request to the network interface controller:
the software module of the network interface controller: configured to obtain the live migration request, and based on the live migration request, allow the use of the software module of the network interface controller to perform an RDMA message forwarding operation, and prohibit the use of the hardware module of the network interface controller from performing the RDMA message forwarding operation: then determine a current physical machine and a target physical machine which correspond to the to-be-migrated virtual machine, and generate, in the current physical, a relay routing corresponding to the to-be-migrated virtual machine, where the relay routing is used to identify a mapping relationship between the current physical machine and the target physical machine: and migrate the to-be-migrated virtual machine from the current physical machine into the target physical machine based on the relay routing and the live migration request.

According to the technical solutions provided by the embodiments, in the process of conducting live migration, through obtaining the current physical machine and the target physical machine of the to-be-migrated virtual machine, and generating the relay routing corresponding to the to-be-migrated virtual machine in the current physical machine, when the to-be-migrated virtual machine on the current physical machine is synchronized to the target physical machine, the RDMA access of other physical machines to the current physical machine undergoing the live migration operation can be not interrupted and the RDMA data can be not lost, thereby effectively ensuring that the traffic is uninterrupted during the whole RDMA live migration process based on the overlay network architecture, and making users unaware, which further improves the good usage experience of the users and ensures the practicability of the technical solutions.

Some implementations of the present disclosure will be described in detail below with reference to the accompanying drawings. The following embodiments and features therein may be combined with each other as long as there is no conflict between the embodiments.

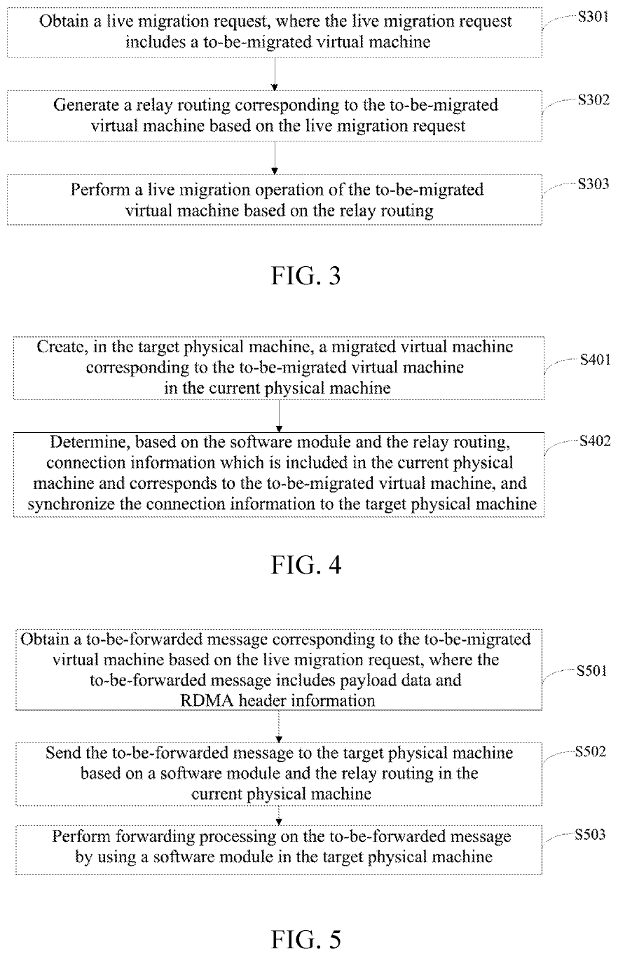

FIG. 3 is a schematic flowchart of a method for live migration based on remote direct memory access provided by an embodiment of the present disclosure. Referring to FIG. 3, this embodiment provides a method for live migration based on remote direct memory access RDMA, and the executive entity of the method is an apparatus for live migration based on remote direct memory access RDMA. It should be understood that the apparatus for live migration based on remote direct memory access RDMA may be implemented as software or a combination of software and hardware. During specific implementation, the apparatus for live migration based on remote direct memory access RDMA may be implemented as a network interface controller structure or a network interface controller node. Specifically, the method for live migration based on remote direct memory access RDMA can include:
step S301, obtain a live migration request, where the live migration request includes a to-be-migrated virtual machine:
step S302, generate a relay routing corresponding to the to-be-migrated virtual machine based on the live migration request:
step S303, perform a live migration operation of the to-be-migrated virtual machine based on the relay routing.

The specific implementation process and implementation effect of each of the steps mentioned above are described in detail below:

Step S301, obtain a live migration request, where the live migration request includes a to-be-migrated virtual machine.

Live migration, i.e., virtual machine saving (save)/restoring (restore) is to completely save the entire running status of a virtual machine, which at the same time, can be quickly restored onto an original hardware platform or even a different hardware platform. After the restoring, the virtual machine still runs smoothly, and users will not notice any difference. When a user has a live migration need, the live migration request can be generated through a physical machine or a virtual machine, where the live migration request includes the to-be-migrated virtual machine on which a live migration operation needs to be performed.

Specifically, the physical machine can provide an interface or port (for example, an interactive interface) for the user to input an executive operation, through which the executive operation input by the user can be obtained. The live migration request can be generated by the executive operation, and after generating the live migration request, the physical machine or the virtual machine can send the live migration request to the network interface controller node. During specific implementation, the physical machine or the virtual machine is configured thereon with a driver module configured for RDMA data transmission operations, through which the live migration request can be sent by the physical machine or the virtual machine to the network interface controller node so that the network interface controller node can obtain the live migration request.

Step S302, generate a relay routing corresponding to the to-be-migrated virtual machine based on the live migration request.

After obtaining the live migration request, the relay routing corresponding to the to-be-migrated virtual machine can be generated based on the live migration request. In some examples, generating the relay routing corresponding to the to-be-migrated virtual machine based on the live migration request may include: determining, based on the live migration request, a current physical machine and a target physical machine that correspond to the to-be-migrated virtual machine: and generating, in the current physical, the relay routing corresponding to the to-be-migrated virtual machine, where the relay routing is used to identify a mapping relationship between the current physical machine and the target physical machine.

After obtaining the to-be-migrated virtual machine included in the live migration request, the to-be-migrated virtual machine can be analyzed and processed to determine the current physical machine and the target physical machine that correspond to the to-be-migrated virtual machine. Specifically, there is a mapping relationship between the to-be-migrated virtual machine and the current physical machine where the to-be-migrated virtual machine is located, through which the current physical machine corresponding to the to-be-migrated virtual machine can be determined.

After obtaining the to-be-migrated virtual machine, in order to accurately implement the live migration operation, the target physical machine corresponding to the to-be-migrated virtual machine can be determined. The target physical machine may be determined by the system through a preset algorithm. In some examples, the target physical machine may be a physical machine with relatively sufficient data processing resources. In some other examples, the target physical machine may be a preset standby physical machine and so on, as long as the stability and reliability of the live migration operation can be guaranteed.

In addition, when migrating the to-be-migrated virtual machine from the current physical machine to the target physical machine, in order to ensure the RDMA data flow not to be interrupted, the relay routing corresponding to the to-be-migrated virtual machine can be generated in the current physical machine. Specifically, after obtaining the current physical machine and the target physical machine, current configuration information (Internet Protocol (IP for short) address information, Media Access Control (MAC) address information, and the like) of the current physical machine and target configuration information (IP address information, MAC address, and the like) of the target physical machine can be obtained, and then the relay routing is generated based on a mapping relationship between the current configuration information and the target configuration information, where the relay routing is used to identify the mapping relationship between the current physical machine and the target physical machine.

Step S303, perform a live migration operation of the to-be-migrated virtual machine based on the relay routing.

After obtaining the relay routing, the live migration operation of the to-be-migrated virtual machine can be performed based on the relay routing. Specifically, performing the live migration operation of the to-be-migrated virtual machine based on the relay routing may include: determining, based on the live migration request, to perform an RDMA message forwarding operation by using a software module in the network interface controller node: and migrating the to-be-migrated virtual machine from the current physical machine to the target physical machine based on the software module and the relay routing.

Specifically, since the network interface controller node includes a hardware module and a software module, a forwarding operation can be performed on a message to be processed by using the hardware module and the software module when not performing the live migration operation. Specifically, the hardware module may include therein a first flow table for realizing fast forwarding operations, and the software module may include a second flow table for realizing forwarding operations. After obtaining the message to be processed, when the message to be processed hits the first flow table, the forwarding operation can be performed on the message to be processed by using the hardware module and the first flow table: when the message to be processed does not hit the first flow table, the forwarding operation can be performed on the message to be processed by using the software module and the second flow table.

When performing the live migration operation, if the hardware module is allowed to perform the forwarding operation on the message to be processed based on the first flow table at this time, it may easily lead to an exception in the live migration operation since the live migration operation takes a certain amount of time. Therefore, in order to ensure the stability and reliability of the live migration operation, after obtaining the live migration request, based on the live migration request, the use of the hardware module in the network interface controller node to perform an RDMA message forwarding operation may be prohibited, and the use of the software module in the network interface controller node to perform the RDMA message forwarding operation may be allowed.

After obtaining the live migration request, the to-be-migrated virtual machine can be migrated from the current physical machine to the target physical machine by using the software module and the relay routing, to realize the live migration operation.

According to the method for live migration based on remote direct memory access provided by this embodiment, through obtaining the live migration request, generating the relay routing corresponding to the to-be-migrated virtual machine based on the live migration request and performing the live migration operation of the to-be-migrated virtual machine based on the relay routing, it is effectively realized that in the process of conducting live migration, through generating in the current physical machine the relay routing corresponding to the to-be-migrated virtual machine, RDMA access of other physical machines to the current physical machine undergoing the live migration operation can be not interrupted and RDMA data can be not lost, thereby effectively ensuring that the traffic is uninterrupted in the whole RDMA live migration process based on the overlay network architecture and making users unaware, which further improves the good usage experience of the users and ensures the practicability of the technical solution.

FIG. 4 is a schematic flowchart of migrating a to-be-migrated virtual machine from a current physical machine to a target physical machine based on a software module and a relay routing provided by an embodiment of the present disclosure. Referring to FIG. 4, this embodiment provides an implementation of migrating a to-be-migrated virtual machine from a current physical machine to a target physical machine. Specifically, migrating the to-be-migrated virtual machine from the current physical machine to the target physical machine based on the software module and the relay routing in this embodiment may include the following steps.

Step S401, create, in the target physical machine, a migrated virtual machine corresponding to the to-be-migrated virtual machine in the current physical machine.

After obtaining the to-be-migrated virtual machine in the current physical machine, in order to implement the live migration operation, the migrated virtual machine corresponding to the to-be-migrated virtual machine can be created in the target physical machine. In some examples, creating, in the target physical machine, the migrated virtual machine corresponding to the to-be-migrated virtual machine in the current physical machine may include: determining, in the current physical machine, memory information corresponding to the to-be-migrated virtual machine: and iteratively copying the memory information to the target physical machine, to generate the migrated virtual machine corresponding to the to-be-migrated virtual machine.

Specifically, after obtaining the to-be-migrated virtual machine in the current physical machine, the to-be-migrated virtual machine can be analyzed and processed, to determine, in the current physical machine, the memory information corresponding to the to-be-migrated virtual machine: and after determining the memory information corresponding to the to-be-migrated virtual machine, the memory information can be iteratively copied to the target physical machine, so that the migrated virtual machine corresponding to the to-be-migrated virtual machine can be generated, and then the stable creation operation of the migrated virtual machine can be effectively realized.

Step S402, determine, based on the software module and the relay routing, connection information which is included in the current physical machine and corresponds to the to-be-migrated virtual machine, and synchronize the connection information to the target physical machine.

In order to implement the live migration operation, the to-be-migrated virtual machine in the current physical machine can be analyzed and processed based on the software module and the relay routing, to determine the connection information which is included in the current physical machine and corresponds to the to-be-migrated virtual machine, where the connection information includes all connection-related information about the communicative connection with the to-be-migrated virtual machine, for example, IP address information, MAC address information and the like of a third device that communicates with the to-be-migrated virtual machine. After obtaining the connection information, the connection information can be synchronized to the target physical machine, so that the target physical machine can learn all relevant information about the communicative connection with the to-be-migrated virtual machine, thereby ensuring the normal operation of the live migration operation.

It should be noted that the execution sequence between steps S401 and S402 mentioned above in this embodiment is not limited to the sequence described by the sequence numbers mentioned above. Those skilled in the art can adjust the specific execution sequence of the steps mentioned above according to specific application scenarios or application requirements, for example, steps S401 and S402 can be executed at the same time, or step S401 can be executed after step S402.

In some other examples, after creating, in the current physical machine, the migrated virtual machine corresponding to the to-be-migrated virtual machine, the method in this embodiment may further include: pausing the to-be-migrated virtual machine located in the current physical machine, and starting the migrated virtual machine located in the target physical machine.

Specifically, after creating, in the target virtual machine, the migrated virtual machine corresponding to the to-be-migrated virtual machine in the current physical machine, in order to implement the migration of the data corresponding to the to-be-migrated virtual machine in the current physical machine to the target physical machine, the to-be-migrated virtual machine located in the current physical machine can be paused, that is, to control the to-be-migrated virtual machine in the current physical machine to stop running and start the migrated virtual machine located in the target physical machine. The migrated virtual machine corresponds to the to-be-migrated virtual machine, so that the data for the to-be-migrated virtual machine in the paused state that is obtained by the current physical machine can be migrated to the migrated virtual machine that has been started, thereby facilitating the implementation of the live migration operation of data.

In this embodiment, through creating, in the target physical machine, the migrated virtual machine corresponding to the to-be-migrated virtual machine in the current physical machine, then determining the connection information which is included in the current physical machine and corresponds to the to-be-migrated virtual machine, and synchronizing the connection information to the target physical machine, it is effectively achieved that the to-be-migrated virtual machine can be migrated from the current physical machine to the target physical machine based on the relay routing and the live migration request, which is conducive to ensuring the stability and reliability of the live migration operation.

FIG. 5 is another schematic flowchart of migrating a to-be-migrated virtual machine from a current physical machine to a target physical machine based on a software module and a relay routing provided by an embodiment of the present disclosure. Referring to FIG. 5, this embodiment provides an implementation of migrating a to-be-migrated virtual machine from a current physical machine to a target physical machine. Specifically, migrating the to-be-migrated virtual machine from the current physical machine to the target physical machine based on the software module and the relay routing in this embodiment may include the following steps.

Step S501, obtain a to-be-forwarded message corresponding to the to-be-migrated virtual machine based on the live migration request, where the to-be-forwarded message includes payload data and RDMA header information.

After obtaining the live migration request, in order to implement the live migration operation of data, the to-be-forwarded message corresponding to the to-be-migrated virtual machine can be obtained based on the live migration request. At this time, the to-be-forwarded message may include the payload data and the RDMA header information, where the RDMA header information may include direct data placement (DDP for short) information and marker-based protocol data unit aligned (MPA for short) header information.

Step S502, send the to-be-forwarded message to the target physical machine based on a software module and the relay routing in the current physical machine.

After obtaining the to-be-forwarded message, since the relay routing includes the mapping relationship between the current physical machine and the target physical machine, the to-be-forwarded message can be sent to the target physical machine based on the software module and the relay routing in the current physical machine, that is, it is achieved that the to-be-forwarded message received by the current physical machine is migrated to the target physical machine for processing.

Step S503, perform forwarding processing on the to-be-forwarded message by using a software module in the target physical machine.

After the target physical machine obtains the to-be-forwarded message, forwarding processing can be performed on the to-be-forwarded message by using the software module in the target physical machine, to achieve the live migration operation of data. In some examples, performing forwarding processing on the to-be-forwarded message by using the software module in the target physical machine may include: performing encapsulating processing on a header of the to-be-forwarded message by using a second flow table in the software module, to obtain a first message: determining a location information table included in the software module, where the location information table includes a destination node corresponding to the to-be-forwarded message and an IP corresponding relationship between physical machines where destination nodes are located: performing Vxlan encapsulating on the first message by using the location information table, to obtain a second message: and performing forwarding processing on the second message.

The target physical machine includes a hardware module and the software module, and the software module may include the second flow table for analyzing and processing the to-be-forwarded message. Since the to-be-forwarded message only includes the payload data and the RDMA header information at this time, in order to achieve normal processing operations of the to-be-forwarded message, after the target physical machine obtains the to-be-forwarded message, encapsulating processing can be performed on the header of the to-be-forwarded message by using the second flow table in the software module. At this point, the header may include transmission control protocol TCP header information, Internet protocol IP header information, media access control MAC header information, and so on, so that the first message can be obtained.

In addition, in order to normally forward the to-be-forwarded message to a target node, after obtaining the to-be-forwarded message, the location information table included in the software module can be obtained. The location information table includes the destination node corresponding to the to-be-forwarded message and the IP corresponding relationship between the physical machines where the destination nodes are located. After obtaining the location information table, Vxlan encapsulating can be performed on the first message by using the location information table, to obtain the second message. In some examples, performing Vxlan encapsulating on the first message by using the location information table, to obtain the second message may include: obtaining Vxlan header information, outer user datagram protocol UDP header information, IP header information and MAC header information that correspond to the first message: encapsulating the Vxlan header information, the user datagram protocol UDP header information, the IP header information and the MAC header information by using the location information table, to obtain the second message. That is, a complete message encapsulated with the relevant information of the target node can be obtained.

After obtaining the second message, forwarding processing can be performed on the second message by using the second flow table included in the software module, that is, the second message is sent to the physical machine where the target node is located based on the second flow table, to achieve sending the second message to the target node, thereby effectively realizing the message forwarding operation.

In this embodiment, the to-be-forwarded message corresponding to the to-be-migrated virtual machine is obtained based on the live migration request, then the to-be-forwarded message is sent to the target physical machine based on the software module and relay routing in the current physical machine, and forwarding processing is performed on the to-be-forwarded message by using the software module in the target physical machine. In this way, it is effectively achieved that after obtaining the live migration request, the to-be-forwarded message which is obtained by the current physical machine and corresponds to the to-be-migrated virtual machine can be migrated to the target physical machine for analyzing and processing, thereby realizing the live migration operation of data and further ensuring the stability and reliability of the method for live migration.

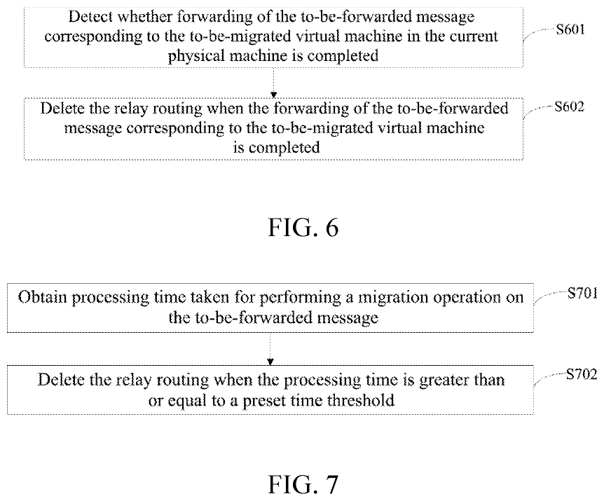

FIG. 6 is a schematic flowchart of another method for live migration based on remote direct memory access provided by an embodiment of the present disclosure. Referring to FIG. 6, after obtaining the to-be-forwarded message corresponding to the to-be-migrated virtual machine based on the live migration request, the method in this embodiment may further include the following steps.

Step S601, detect whether forwarding of the to-be-forwarded message corresponding to the to-be-migrated virtual machine in the current physical machine is completed.

Step S602, delete the relay routing when the forwarding of the to-be-forwarded message corresponding to the to-be-migrated virtual machine is completed.

After obtaining the to-be-forwarded message corresponding to the to-be-migrated virtual machine based on the live migration request, a forwarding operation can be performed on the to-be-forwarded message by using the software module in the network interface controller node, to implement the live migration operation for the data of the to-be-migrated virtual machine. During conducting the live migration operation, it is possible to detect and obtain whether the forwarding of the to-be-forwarded message corresponding to the to-be-migrated virtual machine in the current physical machine is completed. In some examples, the current physical machine is configured with a state machine corresponding to the to-be-migrated virtual machine, and whether the forwarding of the to-be-forwarded message corresponding to the to-be-migrated virtual machine in the current physical machine is completed can be obtained through a state identifier in the state machine. In some other examples, all to-be-forwarded messages corresponding to the to-be-migrated virtual machine in the current physical machine are obtained in advance, and whether the forwarding of the to-be-forwarded message corresponding to the to-be-migrated virtual machine is completed is determined by obtaining a forwarding state of the last to-be-forwarded message among all the to-be-forwarded messages. For example, if the forwarding of the last to-be-forwarded message is completed, it can be determined that the forwarding of the to-be-forwarded message corresponding to the to-be-migrated virtual machine is completed, otherwise, it can be determined that the forwarding of the to-be-forwarded message corresponding to the to-be-migrated virtual machine has not been completed.

When a result of the detection is that the forwarding of the to-be-forwarded message corresponding to the to-be-migrated virtual machine is completed, at this time, the relay routing in the current physical machine has completed a corresponding relay function, and thus the relay routing can be deleted. When the result of the detection is that the forwarding of the to-be-forwarded message corresponding to the to-be-migrated virtual machine has not been completed, at this time, the relay routing in the current physical machine has not completed the corresponding relay function, and thus it is necessary to continue reserving the relay routing in the current physical machine.

In this embodiment, through detecting whether the forwarding of the to-be-forwarded message corresponding to the to-be-migrated virtual machine in the current physical machine is completed, and deleting the relay routing when the result of the detection is that the forwarding of the to-be-forwarded message corresponding to the to-be-migrated virtual machine is completed, while continuing to reserve the relay routing when the result of the detection is that the forwarding of the to-be-forwarded message corresponding to the to-be-migrated virtual machine has not been completed, it is effectively realized that when the relay routing has not completed the relay function between the current physical machine and the target physical machine, the relay routing can be reserved in the current physical machine, and when the relay routing has completed the relay function between the current physical machine and the target physical machine, the relay routing can be deleted in order to further reduce the memory occupancy of the current physical machine, which further improves the flexibility and reliability of the method.

FIG. 7 is a schematic flow chart of still another method for live migration based on remote direct memory access provided by an embodiment of the present disclosure. Referring to FIG. 7, after obtaining the to-be-forwarded message corresponding to the to-be-migrated virtual machine based on the live migration request, the method further includes the following steps.

Step S701, obtain processing time taken for performing a migration operation on the to-be-forwarded message.

Step S702, delete the relay routing when the processing time is greater than or equal to a preset time threshold.

After obtaining the to-be-forwarded message corresponding to the to-be-migrated virtual machine based on the live migration request, in order to accurately control the live migration operation, the processing time taken for performing the migration operation on the to-be-forwarded message can be obtained. Specifically, the current physical machine can be configured with a timer. After generating the relay routing, the timer is started for timing, and when performing the migration operation on the message to be migrated, the processing time can be obtained through the timer.

In general, when performing migration operations on all the to-be-forwarded messages in a virtual machine, the time required is relatively short, such as 1 minute, 2 minutes, 3 minutes, or 5 minutes, etc. In order to accurately detect whether the forwarding of the to-be-forwarded messages corresponding to the to-be-migrated virtual machine in the current physical machine is completed, the preset time threshold for analyzing and processing the processing time is pre-configured. After obtaining the processing time, the processing time and the preset time threshold can be analyzed and compared with each other. When the processing time is greater than or equal to the preset time threshold, it can be determined that the forwarding of the to-be-forwarded messages corresponding to the to-be-migrated virtual machine in the current physical machine is completed, and thus the relay routing can be deleted. Otherwise, when the processing time is smaller than the preset time threshold, it can be determined that the forwarding of the to-be-forwarded messages corresponding to the to-be-migrated virtual machine in the current physical machine has not been completed, and thus the relay routing can be reserved unchanged.

On the basis of the embodiment corresponding to FIG. 6 or the embodiment corresponding to FIG. 7, after deleting the relay routing, the method further includes: allowing to use a hardware module and the software module in the network interface controller node to perform message forwarding processing.

When the relay route is deleted, it means that the live migration operation has been completed at this time, and then in order to improve the quality and efficiency of message forwarding, the software module and the hardware module in the network interface controller node can be allowed to perform a forwarding operation on the message. Specifically, when the to-be-forwarded message hits the first flow table in the hardware module, the forwarding operation can be performed on the to-be-forwarded message by directly using the hardware module and the first flow table: and when the to-be-forwarded message does not hit the first flow table in the hardware module, the hardware module can send the to-be-forwarded message to the software module, so that the software module and the second flow table are used to perform the normal message forwarding operation on the to-be-forwarded message, which can effectively improve the efficiency of the message forwarding.

In this embodiment, through obtaining the processing time taken for performing the migration operation on the to-be-forwarded message, and deleting the relay routing when the processing time is greater than or equal to the preset time threshold and reserving the relay routing unchanged when the processing time is smaller than the preset time threshold, it is effectively realized that when the relay routing has not completed the relay function between the current physical machine and the target physical machine, the relay routing can be reserved in the current physical machine, and when the relay routing has completed the relay function between the current physical machine and the target physical machine, the relay routing can be deleted in order to further reduce the memory occupancy of the current physical machine, thereby further improving the flexibility and reliability of the usage of the method.

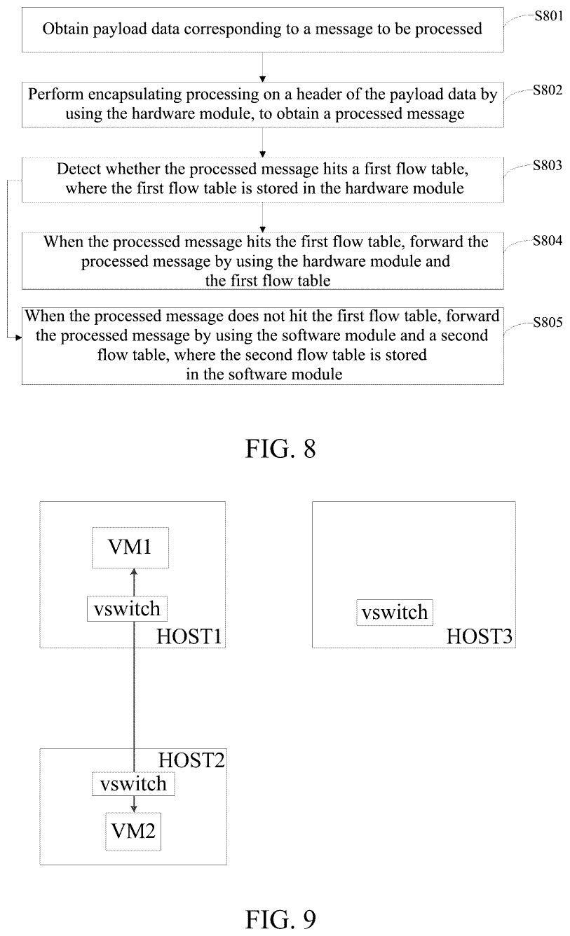

FIG. 8 is a schematic flowchart of yet another method for live migration based on remote direct memory access provided by an embodiment of the present disclosure. Referring to FIG. 8, in order to further improve the quality and efficiency of message forwarding, when allowing to use the hardware module and the software module in the network interface controller node to perform message forwarding processing, the method in this embodiment may further include the following steps.

Step S801, obtain pay load data corresponding to a message to be processed.

When a user has a data access need, the message to be processed can be generated by a physical machine or a virtual machine. The message to be processed may be an RDMA message, and the generated message to be processed at this time includes only the payload data. Specifically, a physical machine can provide an interface or port used for the user to input an executive operation, through which the executive operation input by the user can be obtained, and the message to be processed can be generated by the executive operation. It can be understood that in different application scenarios, the generated messages to be processed can correspondingly have different functions, for example, a message to be processed for realizing a data access operation, a message to be processed for realizing a control operation, a message to be processed for realizing a response operation, and so on.

After the physical machine or the virtual machine generates the message to be processed, the message to be processed can be sent to the network interface controller node. It can be understood that the number of messages to be processed that the network interface controller node can obtain may be one or more. During specific implementation, the physical machine or the virtual machine is configured with a driver module configured for RDMA data transmission operations, through which the message to be processed can be sent by the physical machine or the virtual machine to the network interface controller node so that the network interface controller mode can obtain the payload data corresponding to the message to be processed.

Step S802, perform encapsulating processing on a header of the payload data by using the hardware module, to obtain a processed message.

The network interface controller node may include a hardware module and a software module. The hardware module is configured to implement encapsulating, decapsulating and fast forwarding operations of messages: the software module is configured to implement normal forwarding and state management operations of messages. The hardware module can be implemented by an FPGA or an ASIC, and the software module can be implemented by a CPU. After the network interface controller node obtains the payload data, in order to enable the technical solution applicable to the overlay network architecture, encapsulating processing can be performed on the header of the payload data by using the hardware module in the network interface controller node. The header of the payload data may include transmission control protocol TCP header information, Internet protocol IP header information and media access control MAC header information, so that a complete processed message can be obtained, and the processed message can be transmitted in the overlay network architecture.

Step S803, detect whether the processed message hits a first flow table, where the first flow table is stored in the hardware module.

For the network interface controller node, the hardware module pre-stores the first flow table for realizing traffic fast forwarding operations, and the software module pre-stores a second flow table for realizing traffic forwarding operations. After the hardware module obtains the processed message, the processed message can be analyzed and detected, to detect whether the processed message hits the first flow table. Specifically, detecting whether the processed message hits the first flow table may include: determining 5-tuple information (a source IP address, a destination IP address, a protocol number, a source port, a destination port) and executive operation information which correspond to the processed message, and detecting whether the processed message hits the first flow table based on a 5-tuple and an executive operation. When the first flow table includes the 5-tuple and the executive operation which correspond to the processed message, it is determined that the processed message hits the first flow table: when the first flow table does not include the 5-tuple and the executive operation which correspond to the processed message, it is determined that the processed message does not hit the first flow table.

Step S804, when the processed message hits the first flow table, forward the processed message by using the hardware module and the first flow table.

When the processed message hits the first flow table, it means that the hardware module can directly perform the forwarding operation on the processed message at this time, and thus the forwarding operation can be performed on the processed message by directly using the hardware module and the first flow table, which is beneficial to improving the quality and efficiency of performing the forwarding operation on the processed message.

Step S805, when the processed message does not hit the first flow table, forward the processed message by using the software module and a second flow table, where the second flow table is stored in the software module.

When the processed message does not hit the first flow table, it means that the hardware module cannot directly perform the forwarding operation on the processed message at this time, and thus the forwarding operation can be performed on the processed message by using the software module in the network interface controller node and the second flow table stored in the software module, thereby effectively realizing the normal forwarding operation of the processed message.

In some other examples, in order to improve the practicality of this method, after forwarding the processed message by using the software module in the network interface controller node and the second flow table, the method in this embodiment may further include: obtaining a target second flow table corresponding to the processed message: and sending the target second flow table to the hardware module to serve as the first flow table.

Specifically, after forwarding the processed message by using the software module in the network interface controller node and the second flow table, since the hardware module does not include the first flow table corresponding to the processed message at this time, in order to improve the quality and efficiency of forwarding operations for subsequent messages to be processed, the software module can obtain the target second flow table corresponding to the processed message, and then send the target second flow table to the hardware module to serve as the first flow table, thereby effectively realizing continuous updating operations of the first flow table.

For example, a network interface controller node in a certain area can obtain a message to be processed of user A and a message to be processed of user B. At this time, a software module in the network interface controller node includes second flow tables corresponding to user A and user B, and the hardware module includes first flow tables corresponding to user A and user B. When the network interface controller node receives a message to be processed of user C for the first time, the hardware module in the network interface controller node does not include a first flow table corresponding to user C, and therefore forwarding processing is performed on the message to be processed of user C by using the software module in the network interface controller node. After the processing, a target second flow table corresponding to the message to be processed of user C can be obtained, and the target second flow table is sent to the hardware module to serve as the first flow table. At this time, the first flow tables included in the hardware module include: the first flow table corresponding to user A, the first flow table corresponding to user B, and a fast forwarding procedure corresponding to user C.

In this way, when a message to be processed corresponding to user C is obtained later, the hardware module in the network interface controller node can be directly used to perform forwarding processing on the message to be processed, which is beneficial to improving the quality and efficiency of the message forwarding operation and reducing the delay of message forwarding.

In this embodiment, the payload data corresponding to the message to be processed is obtained, and encapsulating processing is performed on the message header of the payload data by the hardware module in the network interface controller node to obtain the processed message. Then whether the processed message hits the first flow table is detected, and the processed message is forwarded by using the hardware module and the first flow table when the processed message hits the first flow table, while the processed message is forwarded by using the software module in the network interface controller node and the second flow table when the processed message does not hit the first flow table. In this way, the processing operations of messages are effectively realized by combining software and hardware. Specifically, the hardware part can be responsible for the encapsulating/decapsulating processing of messages and the fast forwarding operations of messages, and the software part is responsible for the normal forwarding operations of messages, focusing on state management, thus realizing the balance between the performance and flexibility of the network, which is conducive to reducing the demand for bandwidth and processor overhead and significantly reducing the delay. In addition, the application of the RDMA technology can be realized based on the overlay network architecture, and the implementation details of the physical network are shielded, therefore, there is no restriction on the scope of the physical network and no restriction on the same subnet communication. In addition, the technical solution can reuse the virtual switch processing logic of normal VPC network traffic, such as a security group, thereby further improving the practicability of the method for live migration.

In a specific application, an application embodiment provides a method for live migration based on remote direct memory access RDMA, which can effectively realize the technical purpose of users being unaware of a live migration operation in an RDMA network, and is beneficial to the development of message processing technologies. For ease of understanding, referring to FIG. 9, an initial state is: virtual machine VM1 runs on physical machine HOST1, where HOST1 includes virtual switch vswitch, and virtual machine VM2 runs on physical machine HOST2, where HOST2 includes virtual switch vswitch: VM1 and VM2 conduct data communication through RDMA. Now VM1 needs to be lively migrated to physical machine HOST3, where HOST3 includes virtual switch vswitch. At this point, the method for live migration can include the steps as follows.

Step 1, obtain a live migration request, where the live migration request includes VM1 to be migrated. The source end where VM1 is located is HOST1, and the destination end corresponding to VM1 is HOST3.

In order to ensure the stable operation of the live migration, after the live migration starts, the RDMA traffic forwarding operation can be switched from the hardware part in the network interface controller node to the software part in the network interface controller node.

Step 2, iteratively copy a memory in VM1 based on the live migration request to create an RDMA device in HOST3.

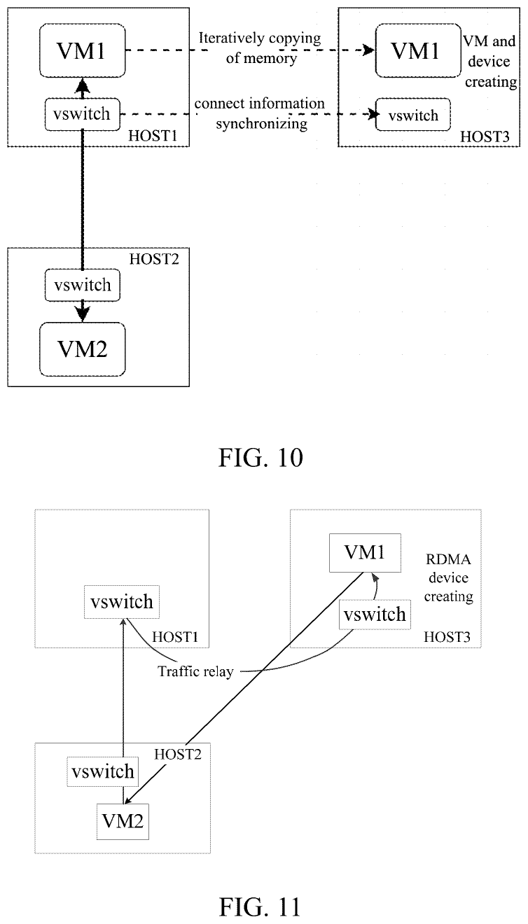

Referring to FIG. 10, live migration programs on HOST1 and HOST3 are started respectively. VM1 is started on HOST3 according to the same configuration as that on HOST1, but the VM1 state in HOST3 is configured to the paused state and a corresponding RDMA device is created. Then, HOST1 continuously and iteratively copies the memory of VM1 to VM1 on HOST3. Simultaneously, information related to VM1 in an RDMA connection information (connect information) table of the virtual switch vswitch in HOST1 is synchronized to the virtual switch vswitch of the destination HOST3.

Step 3, a relay phase of RDMA traffic.

Referring to FIG. 11, when VM1 synchronizes all the memory to HOST3, VM1 on HOST1 is stopped and VM1 on HOST3 is started. However, since the location information table of vswitch on HOST2 has not been updated at this time, and the recorded information is still that VM1 is on HOST1, RDMA traffic sent by HOST2 to VM1 may still be sent to HOST1.

After the RDMA traffic is sent to HOST1, in order to let HOST2 learn, through the vswitch on HOST1, that VM1 has been migrated to HOST3, a relay routing is configured in the location information table of HOST1. This relay routing is used to identify the mapping relationship between the current physical machine and the target physical machine, that is, other access nodes can learn through the relay routing that the source end of vm1 has been changed from HOST1 to HOST3. Therefore, when HOST1 obtains the traffic corresponding to vm1, the traffic can be relayed to HOST3 for processing through the relay routing, thereby realizing that the RDMA traffic is not interrupted during the live migration process. Specifically, the format of the relay routing is as shown in Table 1 below. The relay routing includes: vm ip, host ip and a version field. Whenever the host ip corresponding to the vm ip changes, the version field will be incremented by 1. And, since the relay routing is located on the current host before the change, the relay routing can identify the mapping relationship between the current physical machine before the change and the target physical machine after the change.

TABLE 1
Relay routing

| Id | Vm ip | Host ip | version |
|---|---|---|---|
| 1 | 192.168.0.1 | 10.0.0.1 | 1 |
| 2 | 192.168.0.2 | 10.0.0.2 | 1 |
| 3 | . . . | . . . | . . . |

In addition, in order to achieve the stable migration operation of the message corresponding to VM1, when an RDMA message in VM1 is obtained, it may be a physical machine or a virtual machine who sent the RDMA message in VM1. When the network interface controller node obtains the RDMA message, the hardware part in the network interface controller node obtains the RDMA message and detects whether the RDMA message hits the first flow table in the hardware part. If the RDMA message hits the first flow table, the forwarding operation on the RDMA message can be performed by using the hardware part and the first flow table directly: if the RDMA message does not hit the first flow table, the RDMA message is delivered to the software vswitch of CPU for processing.

After the software vswitch obtains the RDMA message, forwarding processing can be performed on the RDMA message by using the second flow table. After the forwarding processing is performed on the RDMA message, the second flow table corresponding to the RDMA message can be sent to the hardware part to serve as the first flow table, so that if a subsequent message hits the first flow table, the first flow table on the hardware part can be directly used for the forwarding operation.

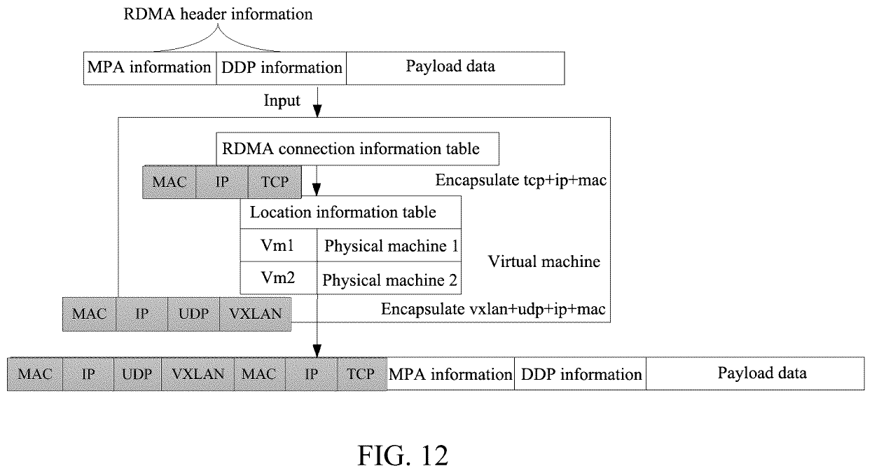

When the forwarding processing is performed on the RDMA message by using the second flow table, as shown in FIG. 12, the second flow table can be first used to perform encapsulating processing on a header of the RDMA message. Specifically, the encapsulating processing can be performed on transmission control protocol TCP header information, Internet Protocol IP header information and Media Access Control MAC header information, so that a first message can be obtained. Then the location information table included in the software module is determined. The location information table includes a destination node corresponding to the to-be-forwarded message and an IP corresponding relationship between physical machines where destination nodes are located. After the location information table is obtained, the location information table can be used for encapsulating Vxlan header information, outer user datagram protocol UDP header information, IP header information and MAC header information that correspond to the first message, to obtain a second message. The second message may include: payload data, MPA information, DDP information: MAC information, IP information, UDP information and Virtual extensible Local Area Network (VXLAN) information that are encapsulated through the location information table: MAC information, IP information and TCP information that are encapsulated through the second flow table. Then the forwarding processing can be performed on the second message, so that the normal processing operation of the RDMA message can be effectively realized.

Step 4, all HOST location information configuration updates are completed, and the migration phase ends.

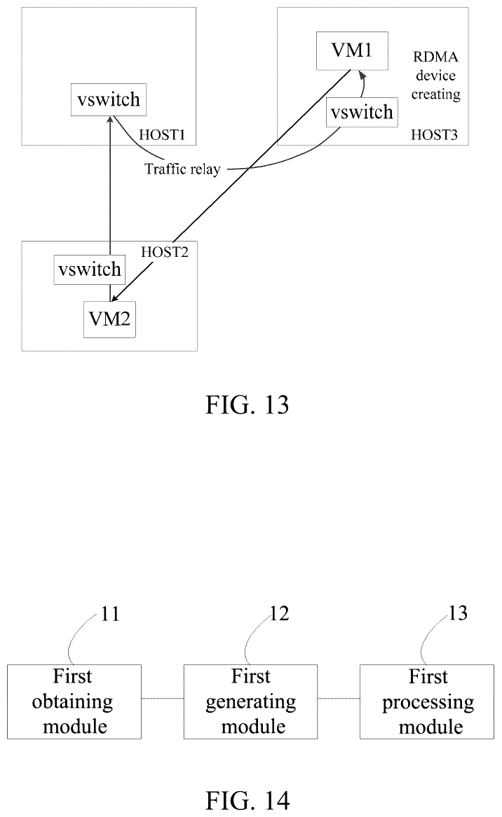

Referring to FIG. 13, after the mapping information of VM1 in the vswitch location information tables of all HOSTs in the global is updated from “VM1-HOST1” to “VM1-HOST3”, HOST1 can delete the relay routing in vswitch. Specifically, a specific implementation of deleting the relay routing can be completed through a timer. For example, if updating the vswitch location information tables of all HOSTs in the global takes 1 minute, HOST1 may set a timer greater than 1 minute (2 minutes, 3 minutes, or 5 minutes, etc.) to delete the relay routing. After that, after all the live migration procedures are finished, VM1 on HOST3 and VM2 on HOST2 continue to communicate. During the entire live migration operation, it is imperceptible to VM1 and VM2.

In the technical solution provided by this application embodiment, the forwarding processing procedure of the overlay RDMA message is divided into two parts, namely, inner-layer message encapsulating and outer-layer vxlan message encapsulating. The inner-layer message encapsulating obtains information through the RDMA connection information table, so that in the process of live migration, after the VM located in HOST1 is migrated to the destination end through the HOST RDMA connection information table between source ends and destination ends, the link of the RDMA message is not lost, and a relay routing is introduced into the source end vswitch, thereby effectively realizing the uninterrupted RDMA access by other VMs to the VM subject to the live migration, ensuring that traffic is uninterrupted in the whole migration process of the overlay RDMA VM, and making users unaware, which further improves the stability and reliability of the usage of the method and good experience of users.

FIG. 14 is a schematic structural diagram of an apparatus for live migration based on remote direct memory access provided by an embodiment of the present disclosure. Referring to FIG. 14, this embodiment provides an apparatus for live migration based on remote direct memory access, which can implement the method for live migration based on remote direct memory access as shown in FIG. 3. Specifically, the live migration apparatus can include:
a first obtaining module 11, configured to obtain a live migration request, where the live migration request includes a to-be-migrated virtual machine:
a first generating module 12, configured to generate a relay routing corresponding to the to-be-migrated virtual machine based on the live migration request:
a first processing module 13, configured to perform a live migration operation of the to-be-migrated virtual machine based on the relay routing.

In some examples, when the first generating module 12 generates the relay routing corresponding to the to-be-migrated virtual machine based on the live migration request, the first generating module 12 is configured to: determine, based on the live migration request, a current physical machine and a target physical machine which correspond to the to-be-migrated virtual machine: and generate, in the current physical, the relay routing corresponding to the to-be-migrated virtual machine, where the relay routing is used to identify a mapping relationship between the current physical machine and the target physical machine.

In some examples, when the first processing module 13 performs the live migration operation of the to-be-migrated virtual machine based on the relay routing, the first processing module 13 is configured to: determine, based on the live migration request, to perform an RDMA message forwarding operation by using a software module in a network interface controller node: and migrate the to-be-migrated virtual machine from the current physical machine to the target physical machine based on the software module and the relay routing.

In some examples, when the first processing module 13 migrates the to-be-migrated virtual machine from the current physical machine to the target physical machine based on the software module and the relay routing, the first processing module 13 is configured to: create, in the target physical machine, a migrated virtual machine corresponding to the to-be-migrated virtual machine in the current physical machine: determine, based on the software module and the relay routing, connection information which is included in the current physical machine and corresponds to the to-be-migrated virtual machine, and synchronize the connection information to the target physical machine.

In some examples, when the first processing module 13 creates, in the target physical machine, the migrated virtual machine corresponding to the to-be-migrated virtual machine in the current physical machine, the first processing module 13 is configured to: determine, in the current physical machine, memory information corresponding to the to-be-migrated virtual machine: and iteratively copy the memory information to the target physical machine, to generate the migrated virtual machine corresponding to the to-be-migrated virtual machine.

In some examples, after creating the migrated virtual machine corresponding to the to-be-migrated virtual machine in the current physical machine, the first processing module 13 in this embodiment is configured to: pause the to-be-migrated virtual machine located in the current physical machine, and start the migrated virtual machine located in the target physical machine.

In some examples, when the first processing module 13 migrates the to-be-migrated virtual machine from the current physical machine to the target physical machine based on the software module and the relay routing, the first processing module 13 is configured to: obtain a to-be-forwarded message corresponding to the to-be-migrated virtual machine based on the live migration request, where the to-be-forwarded message includes payload data and RDMA header information: send the to-be-forwarded message to the target physical machine based on the software module and the relay routing in the current physical machine: and perform forwarding processing on the to-be-forwarded message by using a software module in the target physical machine.

In some examples, when the first processing module 13 performs forwarding processing on the to-be-forwarded message by using the software module in the target physical machine, the first processing module 13 is configured to: perform encapsulating processing on a header of the to-be-forwarded message by using a second flow table in the software module, to obtain a first message: determine a location information table included in the software module, where the location information table includes a destination node corresponding to the to-be-forwarded message and an IP corresponding relationship between physical machines where destination nodes are located: perform Vxlan encapsulating on the first message by using the location information table, to obtain a second message: and perform forwarding processing on the second message.

In some examples, the header of the to-be-forwarded message includes: transmission control protocol TCP header information, Internet protocol IP header information, and media access control MAC header information.

In some examples, when the first processing module 13 performs Vxlan encapsulating on the first message by using the location information table, to obtain the second message, the first processing module 13 is configured to: obtain Vxlan header information, outer user datagram protocol UDP header information, IP header information and MAC header information which correspond to the first message: and encapsulate the Vxlan header information, the user datagram protocol UDP header information, the IP header information and the MAC header information by using the location information table, to obtain the second message.

In some examples, after obtaining the to-be-forwarded message corresponding to the to-be-migrated virtual machine based on the live migration request, the first processing module 13 in this embodiment can be configured to: detect whether forwarding of the to-be-forwarded message corresponding to the to-be-migrated virtual machine in the current physical machine is completed: and delete the relay routing when the forwarding of the to-be-forwarded message corresponding to the to-be-migrated virtual machine is completed.

In some examples, after obtaining the to-be-forwarded message corresponding to the to-be-migrated virtual machine based on the live migration request, the first obtaining module 11 and the first processing module 13 in this embodiment are configured to execute the following steps:
the first obtaining module 11 is configured to obtain processing time taken for performing a migration operation on the to-be-forwarded message:
the first processing module 13 is configured to delete the relay routing when the processing time is greater than or equal to a preset time threshold.

In some examples, after deleting the relay routing, the first processing module 13 in this embodiment is configured to: allow to use a hardware module and the software module in the network interface controller node to perform message forwarding processing.

In some examples, the first obtaining module 11 and the first processing module 13 in this embodiment are configured to perform the following steps:
the first obtaining module 11 is configured to obtain payload data corresponding to a message to be processed:
the first processing module 13 is configured to: perform encapsulating processing on a header of the payload data by using the hardware module, to obtain a processed message: detect whether the processed message hits a first flow table, where the first flow table is stored in the hardware module: when the processed message hits the first flow table, forward the processed message by using the hardware module and the first flow table: when the processed message does not hit the first flow table, forward the processed message by using the software module and a second flow table, where the second flow table is stored in the software module.

The apparatus shown in FIG. 14 can execute the methods of the embodiments as shown in FIG. 2 to FIG. 13. For parts not described in detail in this embodiment, the reference can be made to the relevant description of the embodiments as shown in FIG. 2 to FIG. 13. The implementation process and technical effects of this technical solution can be found in the description of the embodiments as shown in FIG. 2 to FIG. 13, which will not be repeated here. In a possible design, the structure of the apparatus for live migration based on remote

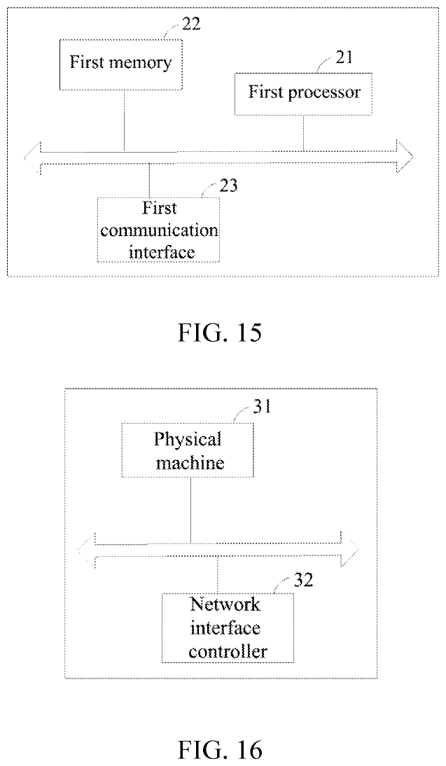

direct memory access as shown in FIG. 14 can be implemented as an electronic device. The electronic device may be a network interface controller device, a server, and other various devices. As shown in FIG. 15, the electronic device can include: a first processor 21 and a first memory 22. The first memory 22 is configured to store a program for the corresponding electronic device to execute the method for live migration based on remote direct memory access provided by the embodiments as shown in FIG. 2 to FIG. 13, and the first processor 21 is configured to execute the program stored in the first memory 22.

The program includes one or more computer instructions, and when the one or more computer instructions are executed by the first processor 21, the following steps can be implemented:
obtain a live migration request, where the live migration request includes a to-be-migrated virtual machine:
generate a relay routing corresponding to the to-be-migrated virtual machine based on the live migration request:
perform a live migration operation of the to-be-migrated virtual machine based on the relay routing.

Further, the first processor 21 is further configured to execute all or part of the steps in the aforementioned embodiments as shown in FIG. 2 to FIG. 13.

The structure of the electronic device may further include a first communication interface 23, which is used for communication between the electronic device and other devices or communication networks.

In addition, an embodiment of the present disclosure provides a computer storage medium for storing computer software instructions used by the electronic device, which includes a program for executing the method for live migration based on remote direct memory access in the method embodiments as shown in FIG. 2-FIG. 13.

FIG. 16 is a schematic structural diagram of another apparatus for live migration based on remote direct memory access provided by an embodiment of the present disclosure. Referring to FIG. 16, this embodiment provides an apparatus for live migration based on remote direct memory access, and the apparatus for live migration is configured to execute the method for live migration based on remote direct memory access in the method embodiment as shown in FIG. 2. Specifically, the apparatus for live migration can include:
a physical machine 31, configured to generate a live migration request, and send the live migration request to a network interface controller 32, where the live migration request includes a to-be-migrated virtual machine:
the network interface controller 32, configured to obtain the live migration request, generate a relay routing corresponding to the to-be-migrated virtual machine based on the live migration request, and perform a live migration operation of the to-be-migrated virtual machine based on the relay routing.

Among them, the network interface controller 32 can include a software module or a hardware module. The software module can include a virtual switch (vswitch) responsible for normal VPC network traffic forwarding operations. Specifically, the software module can obtain a 5-tuple feature of a message and query various forwarding tables such as a routing table, an ACL table and so on through the 5-tuple feature, to obtain a query result, and then generate a second flow table based on the query result and the 5-tuple feature. The hardware module can use a field programmable gate array (FPGA for short) or an application specific integrated circuit (ASIC for short). The hardware module can unload the second flow table issued by the software vswitch.

The network interface controller shown in FIG. 16 can execute the method of the embodiments as shown in FIG. 2 to FIG. 13. For parts not described in detail in this embodiment, the reference can be made to the relevant description of the embodiments as shown in FIG. 2 to FIG. 13. The implementation process and technical effects of this technical solution can be found in the description of the embodiments as shown in FIG. 2 to FIG. 13, which will not be repeated here.

In addition, an embodiment of the present disclosure provides a computer program product, which includes a computer-readable storage medium storing computer instructions which, when executed by one or more processors, cause the one or more processors to execute the steps in the method for live migration based on remote direct memory access in the method embodiments as shown in FIG. 2 to FIG. 13.

The apparatus embodiments described above are only illustrative, the units thereof described as separate components may be or may not be physically separated. The components shown as units may be or may not be physical units, that is, they may be located in a place or distributed onto a plurality of network units. Some or all of the modules therein may be selected according to actual needs to achieve the purposes of the solutions of the embodiments. Persons of ordinary skill in the art can understand and implement the methods without any creative effort.

From the description of the embodiments mentioned above, those skilled in the art can clearly understand that each embodiment can be implemented by adding the necessary general hardware platform, or of course, can also be implemented by combining hardware and software. Based on this understanding, the part that contributes to the prior art or the essence of a technical solution mentioned above can be embodied in the form of a computer product. The present disclosure can take the form of a computer program product embodied on one or more computer usable storage media (including but not limited to a disk storage, a CD-ROM, an optical storage, etc.) containing computer usable program codes.

The present disclosure is described with reference to flowcharts and/or block diagrams of methods, devices (systems), and computer program products according to embodiments of the present disclosure. It will be understood that each procedure and/or block in the flowcharts and/or block diagrams, and combinations of procedures and/or blocks in the flowcharts and/or block diagrams can be implemented by computer program instructions. These computer program instructions can be provided to a processor of a general purpose computer, a special purpose computer, an embedded processor or other programmable devices to produce a machine, such that the instructions executed by the processor of the computer or other programmable devices produce means for implementing the functions specified in one or more procedures of the flowcharts and/or one or more blocks of the block diagrams.

These computer program instructions may also be stored in a computer-readable memory that can cause a computer or other programmable devices to operate in a particular manner, such that the instructions stored in the computer-readable memory produce an article of manufacture including instruction means that performs a function specified in one or more procedures of a flowchart and/or one or more blocks of a block diagram.

These computer program instructions may also be loaded onto a computer or other programmable devices such that a series of operation steps are executed on the computer or other programmable devices to produce computer-implemented processing, whereby the instructions executed on the computer or other programmable devices provide the steps used to implement a function specified in one or more procedures of a flowchart and/or one or more blocks of a block diagram.

In a typical configuration, a computing device includes one or more processors (CPUs), input/output interfaces, network interfaces and memories.

The memories may include volatile storages in computer-readable media, such as a random access memory (RAM), and/or non-volatile memories, such as a read-only memory (ROM) or a flash memory (flash RAM), as well as other forms. A memory is an example of a computer-readable medium.

The computer-readable media include non-volatile and volatile, removable and non-removable media that can realize information storage by any method or technology. Information may be a computer-readable instruction, a data structure, a module of a program, or other data. Examples of the computer storage media of a computer include but are not limited to, a phase-change memory (PRAM), a static random access memory (SRAM), a dynamic random access memory (DRAM), other types of random access memory (RAM), a read-only memory (ROM), an electrically erasable programmable read-only memory (EEPROM), a flash memory or other memory technologies, a compact disc read-only memory (CD-ROM), a digital versatile disk (DVD) or other optical storages, a magnetic cassette, a magnetic tape or magnetic disk storage or other magnetic storage devices or any other non-transmission media that can be used to store information that can be accessed by a computing device. As defined herein, the computer-readable media do not include transitory computer-readable media (transitory media), such as modulated data signals and carrier waves.

Finally, it should be noted that the embodiments described above are only intended to illustrate the technical solutions of the present disclosure, but not to limit them. Although the present disclosure has been described in detail with reference to the foregoing embodiments, those of ordinary skill in the art should understand that they can also modify the technical solutions described in the foregoing embodiments, or equivalently substitute some of the technical features thereof. These modifications or substitutions do not cause the essence of the corresponding technical solutions to deviate from the spirit and scope of the technical solutions of the embodiments of the present disclosure.

1. A method for live migration based on remote direct memory access, comprising:
obtaining a live migration request, wherein the live migration request comprises a to-be-migrated virtual machine;
generating a relay routing corresponding to the to-be-migrated virtual machine based on the live migration request;
performing a live migration operation of the to-be-migrated virtual machine based on the relay routing.

2. The method according to claim 1, wherein the generating the relay routing corresponding to the to-be-migrated virtual machine based on the live migration request comprises:
determining, based on the live migration request, a current physical machine and a target physical machine which correspond to the to-be-migrated virtual machine;
generating, in the current physical machine, the relay routing corresponding to the to-be-migrated virtual machine, wherein the relay routing is used to identify a mapping relationship between the current physical machine and the target physical machine.

3. The method according to claim 2, wherein the performing the live migration operation of the to-be-migrated virtual machine based on the relay routing comprises:
determining, based on the live migration request, to perform an remote direct memory access (RDMA) message forwarding operation by using a software module in a network interface controller node;
migrating the to-be-migrated virtual machine from the current physical machine to the target physical machine based on the software module and the relay routing.

4. The method according to claim 3, wherein the migrating the to-be-migrated virtual machine from the current physical machine to the target physical machine based on the software module and the relay routing comprises:
creating, in the target physical machine, a migrated virtual machine corresponding to the to-be-migrated virtual machine in the current physical machine;
determining, based on the software module and the relay routing, connection information which is comprised in the current physical machine and corresponds to the to-be-migrated virtual machine, and synchronizing the connection information to the target physical machine.

5. The method according to claim 4, wherein the creating, in the target physical machine, the migrated virtual machine corresponding to the to-be-migrated virtual machine in the current physical machine comprises:
determining, in the current physical machine, memory information corresponding to the to-be-migrated virtual machine;
iteratively copying the memory information to the target physical machine, to generate the migrated virtual machine corresponding to the to-be-migrated virtual machine.

6. The method according to claim 4, wherein after creating the migrated virtual machine corresponding to the to-be-migrated virtual machine in the current physical machine, the method further comprises:
pausing the to-be-migrated virtual machine located in the current physical machine, and starting the migrated virtual machine located in the target physical machine.

7. The method according to claim 3, wherein the migrating the to-be-migrated virtual machine from the current physical machine to the target physical machine based on the software module and the relay routing comprises:
obtaining a to-be-forwarded message corresponding to the to-be-migrated virtual machine based on the live migration request, wherein the to-be-forwarded message comprises payload data and RDMA header information;
sending the to-be-forwarded message to the target physical machine based on a software module and the relay routing in the current physical machine;
performing forwarding processing on the to-be-forwarded message by using a software module in the target physical machine.

8. The method according to claim 7, wherein the performing forwarding processing on the to-be-forwarded message by using the software module in the target physical machine comprises:
performing encapsulating processing on a header of the to-be-forwarded message by using a second flow table in the software module, to obtain a first message;
determining a location information table comprised in the software module, wherein the location information table comprises a destination node corresponding to the to-be-forwarded message and an Internet protocol (IP) corresponding relationship between physical machines where destination nodes are located;
performing Vxlan encapsulating on the first message by using the location information table, to obtain a second message;
performing forwarding processing on the second message.

9. The method according to claim 8, wherein the performing Vxlan encapsulating on the first message by using the location information table, to obtain the second message comprises:
obtaining Vxlan header information, outer user datagram protocol (UDP) header information, IP header information and media access control (MAC) header information which correspond to the first message;
encapsulating the Vxlan header information, the UDP header information, the IP header information and the MAC header information by using the location information table, to obtain the second message.

10. The method according to claim 7, wherein after obtaining the to-be-forwarded message corresponding to the to-be-migrated virtual machine based on the live migration request, the method further comprises:
detecting whether forwarding of the to-be-forwarded message corresponding to the to-be-migrated virtual machine in the current physical machine is completed;
deleting the relay routing when the forwarding of the to-be-forwarded message corresponding to the to-be-migrated virtual machine is completed; or
obtaining processing time taken for performing a migration operation on the to-be-forwarded message; deleting the relay routing when the processing time is greater than or equal to a preset time threshold.

11. (canceled)

12. The method according to claim 10-er 11, wherein after deleting the relay routing, the method further comprises:
allowing to use a hardware module and the software module in the network interface controller node to perform message forwarding processing.

13. The method according to claim 12, further comprising:
obtaining payload data corresponding to a message to be processed;
performing encapsulating processing on a header of the payload data by using the hardware module, to obtain a processed message;
detecting whether the processed message hits a first flow table, wherein the first flow table is stored in the hardware module;
when the processed message hits the first flow table, forwarding the processed message by using the hardware module and the first flow table;
when the processed message does not hit the first flow table, forwarding the processed message by using the software module and a second flow table, wherein the second flow table is stored in the software module.

14. An apparatus for live migration based on remote direct memory access, comprising:
a physical machine, configured to generate a live migration request, and send the live migration request to a network interface controller, wherein the live migration request comprises a to-be-migrated virtual machine;
the network interface controller, configured to obtain the live migration request, generate a relay routing corresponding to the to-be-migrated virtual machine based on the live migration request; and
perform a live migration operation of the to-be-migrated virtual machine based on the relay routing.

15. An electronic device, comprising: a memory and a processor; wherein the memory is configured to store one or more computer instructions, and when the one or more computer instructions are executed by the processor, the processor is enabled to:
obtain a live migration request, wherein the live migration request comprises a to-be-migrated virtual machine;
generate a relay routing corresponding to the to-be-migrated virtual machine based on the live migration request;
perform a live migration operation of the to-be-migrated virtual machine based on the relay routing.

16. A non-transitory_computer storage medium, wherein the computer storage medium is configured to store a computer program, and when the computer program is executed by a computer, the method for live migration based on remote direct memory access according to claim 1 is implemented.

17. The electronic device according to claim 15, wherein when the one or more computer instructions are executed by the processor, the processor is further enabled to:
determine, based on the live migration request, a current physical machine and a target physical machine which correspond to the to-be-migrated virtual machine;
generate, in the current physical machine, the relay routing corresponding to the to-be-migrated virtual machine, wherein the relay routing is used to identify a mapping relationship between the current physical machine and the target physical machine.

18. The electronic device according to claim 17, wherein when the one or more computer instructions are executed by the processor, the processor is further enabled to:
determine, based on the live migration request, to perform a remote direct memory access (RDMA) message forwarding operation by using a software module in a network interface controller node;
migrate the to-be-migrated virtual machine from the current physical machine to the target physical machine based on the software module and the relay routing.

19. The electronic device according to claim 18, wherein when the one or more computer instructions are executed by the processor, the processor is further enabled to:
create, in the target physical machine, a migrated virtual machine corresponding to the to-be-migrated virtual machine in the current physical machine;
determine, based on the software module and the relay routing, connection information which is comprised in the current physical machine and corresponds to the to-be-migrated virtual machine, and synchronizing the connection information to the target physical machine.

20. The electronic device according to claim 18, wherein when the one or more computer instructions are executed by the processor, the processor is further enabled to:
obtain a to-be-forwarded message corresponding to the to-be-migrated virtual machine based on the live migration request, wherein the to-be-forwarded message comprises payload data and RDMA header information;
send the to-be-forwarded message to the target physical machine based on a software module and the relay routing in the current physical machine;
perform forwarding processing on the to-be-forwarded message by using a software module in the target physical machine.

21. The electronic device according to claim 20, wherein when the one or more computer instructions are executed by the processor, the processor is further enabled to:
detect whether forwarding of the to-be-forwarded message corresponding to the to-be-migrated virtual machine in the current physical machine is completed; delete the relay routing when the forwarding of the to-be-forwarded message corresponding to the to-be-migrated virtual machine is completed; or
obtain processing time taken for performing a migration operation on the to-be-forwarded message; delete the relay routing when the processing time is greater than or equal to a preset time threshold.
